(19) United States
(12) Patent Application Publication
(10) Pub. No.: US 2020/0030167 A1
(43) Pub. Date: Jan. 30, 2020

(54) MOTORIZED ARMCHAIR FOR THE MOVEMENT OF A PERSON, PARTICULARLY A PERSON WITH MOTOR IMPAIRMENTS

(71) Applicant: Andrea PALOMBO, Latina (IT)

(72) Inventor: Andrea PALOMBO, Latina (IT)

(21) Appl. No.: 16/043,769

(22) Filed: Jul. 24, 2018

(51) Int. Cl. A61G 5/10; A61G 5/04; A61G 5/12

(52) U.S. Cl. CPC A61G 5/1067; A61G 5/041; A61G 5/125; A61G 5/122; A61G 5/1051

(57) ABSTRACT

A motorized armchair for the movement of a person with motor impairments includes an adjustable motorized armchair structure having a resting base, a seat and a back oriented with respect to each other and/or moved integrally with respect to each other relative to the ground. The armchair includes at least one mechanical movement system, provided with at least one actuator and kinematic transmission elements to move and/or orient the seat and back.

The armchair includes a support and movement structure to be fixed to the armchair structure between the resting base and ground
having a supporting frame to which at least two driving wheels actuated by at least one motor and two steerable wheels fixed to allow movement of the armchair along the ground. The armchair includes a control interface connected to the motor and actuator to actuate movements of the seat and back and movement of the motorized armchair.

### TECHNICAL FIELD

The present disclosure relates to a motorized armchair for the movement of a person, which is useful and practical particularly but not exclusively in the health field and in the field of personal medical aids.

In particular, the present disclosure is useful to facilitate the movement, both in home environments and in outdoor environments, of people with motor impairments.

### BACKGROUND

For people affected by disabilities or by disorders which compromise their motor abilities, the need is strongly felt to be able to move autonomously in their own home without the aid of anyone, as well as outside the home, for example in a garden.

Motorized armchairs are currently known which are capable of passing automatically from the sitting position to the reclined position and vice versa and/or facilitate for the patient the transition from the armchair itself to another support—such as a bed or a wheelchair—or facilitate the operation of getting up by rising and/or tilting forward.

In greater detail, these motorized armchairs of the known type normally comprise a seat and a back which can be oriented with respect to each other at least between a sitting configuration, in which they are substantially perpendicular, and a reclined configuration, in which they are substantially coplanar.

The seat and the back are furthermore often movable integrally between a lowered position, in which the seat is substantially parallel to the floor, and a raised position, in which the seat is raised and inclined with respect to the floor so as to facilitate, for the patient who is sitting in the chair, the operation of getting up.

In order to perform these movements of the back and seat, motorized armchairs of the known type are provided with one or more mechanical movement systems which comprise one or more electric actuators and associated mechanisms.

Although these motorized armchairs of the known type are useful and practical, they do not allow the person to move from one place to another.

In order to be able to move autonomously, the person must move or be moved from the armchair to a seat of the type commonly known as wheelchair.

Vice versa, wheelchairs of the known type are very useful for movements but do not have the comfort, advantages and functions that are typical of a motorized armchair as described above.

### SUMMARY

The aim of the present disclosure is to provide a motorized armchair that solves the technical problem described above, obviates the drawbacks and overcomes the limitations of the background art, allowing to have the typical convenience, advantages and functions of a motorized armchair of the known type and at the same time be able to move from one place to another.

Within this aim, the present disclosure provides a motorized armchair that is more versatile and comfortable to use than the background art.

The disclosure provides a motorized armchair that can be driven autonomously by the person who is sitting in it.

This aim and these advantages and others which will become better apparent hereinafter are achieved by providing a motorized armchair for the movement of a person, in particular a person with motor impairments, comprising an adjustable motorized armchair structure which comprises:
a resting base adapted to be arranged adjacent to the ground,
a seat and a back which can be oriented with respect to each other and/or moved integrally with respect to each other relative to the ground,
at least one mechanical movement system, provided with at least one actuator and with kinematic transmission means, configured to move and/or orient said seat and said back,

wherein the motorized armchair comprises a support and movement structure adapted to be fixed to said armchair structure, between the resting base and the ground, comprising:
a supporting frame to which at least two driving wheels actuated by at least one motor and at least two steerable wheels are fixed so as to allow the movement of the motorized armchair along said ground;

and in that it comprises furthermore a control interface which is functionally connected to said at least one motor and to said at least one actuator in order to actuate the movements of the seat and of the back and the movement of the motorized armchair.

This aim and these and other advantages are also achieved by providing a support and movement structure according to claim 10.

### BRIEF DESCRIPTION OF THE DRAWINGS

Further characteristics and advantages will become better apparent from the description of a preferred but not exclusive embodiment of a motorized armchair, illustrated by way of non-limiting example with the aid of the accompanying drawings, wherein:

FIG. 1 is a lateral elevation view of the resting base of a possible embodiment of the adjustable motorized armchair structure according to the disclosure;

FIG. 2 is a perspective view of a possible embodiment of the adjustable motorized armchair structure;

FIG. 3 is a side view of the supporting frame;

FIG. 4 is a top view of the supporting frame;

FIG. 5 is a lateral elevation view of the supporting frame fixed to the resting base;

FIG. 6 is a top view of the supporting frame fixed to the resting base;

FIG. 7 is a lateral elevation view of the supporting frame fixed to the resting base and provided with wheels;

FIG. 8 is a top view of the supporting frame of FIG. 7;

FIG. 9 is a lateral elevation view of the supporting frame of FIG. 7 between two steps;

FIG. 10 is a top view of the frame of FIG. 7 provided with housing and bulkheads;

FIG. 11 is a lateral elevation view of a possible embodiment of the motorized armchair according to the disclosure in the sitting and lowered position;

FIG. 12 is a lateral elevation view of the armchair of FIG. 11 in the raised position;

FIG. 13 is a lateral elevation view of a possible embodiment of the motorized armchair according to the disclosure in the reclined position;

FIG. 14 is a top view of a possible embodiment of the motorized armchair in the sitting and lowered position;

FIG. 15 is a top view of the motorized armchair of FIG. 14;

FIG. 16 is an enlarged-scale view of a detail of FIG. 15 related to the dashboard;

FIG. 17 is a block diagram of a possible embodiment of the electronic system of the motorized armchair;

FIG. 18 is a top view of the rotation of the motorized armchair;

FIG. 19 is a top view of the mobility of the motorized armchair;

FIGS. 20 and 21 are top views of possible embodiments of the supporting frame;

FIG. 22 is a front elevation view of a possible embodiment of a motorized armchair without the extractable armrests;

FIG. 23 is a lateral elevation of the armchair of FIG. 22; and

FIG. 24 is a front lateral elevation view of a possible embodiment of a motorized armchair pushed by an operator, highlighting the release device.

### DETAILED DESCRIPTION OF THE DRAWINGS

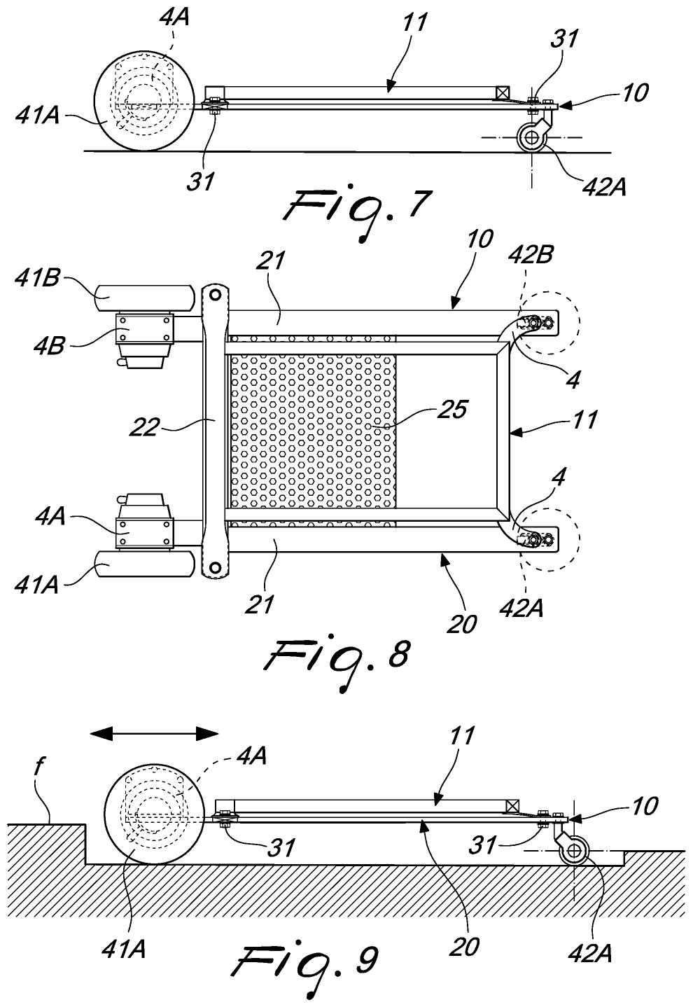

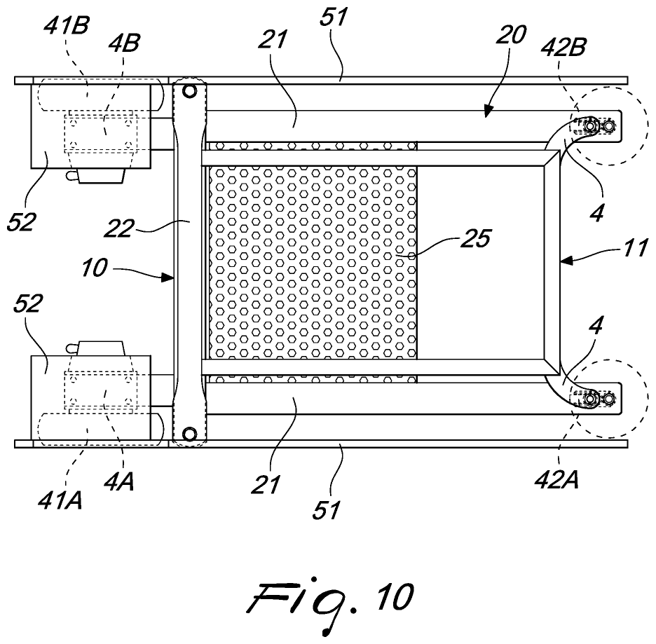

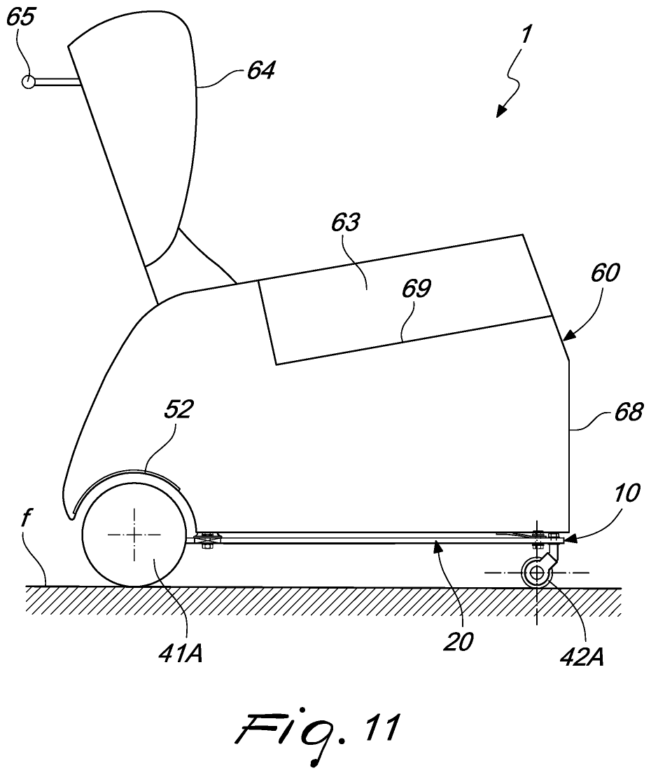

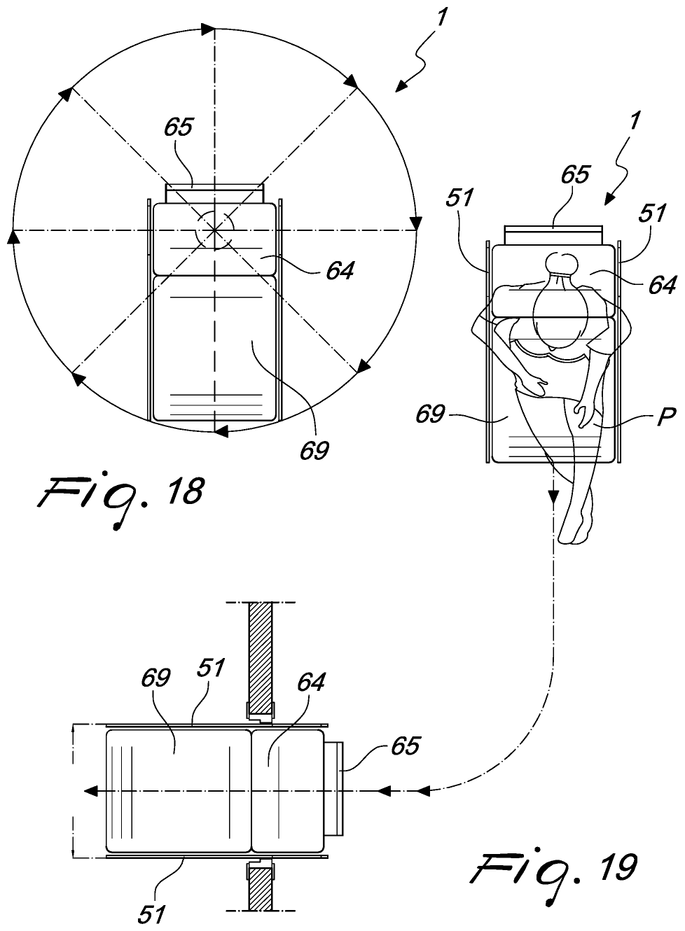

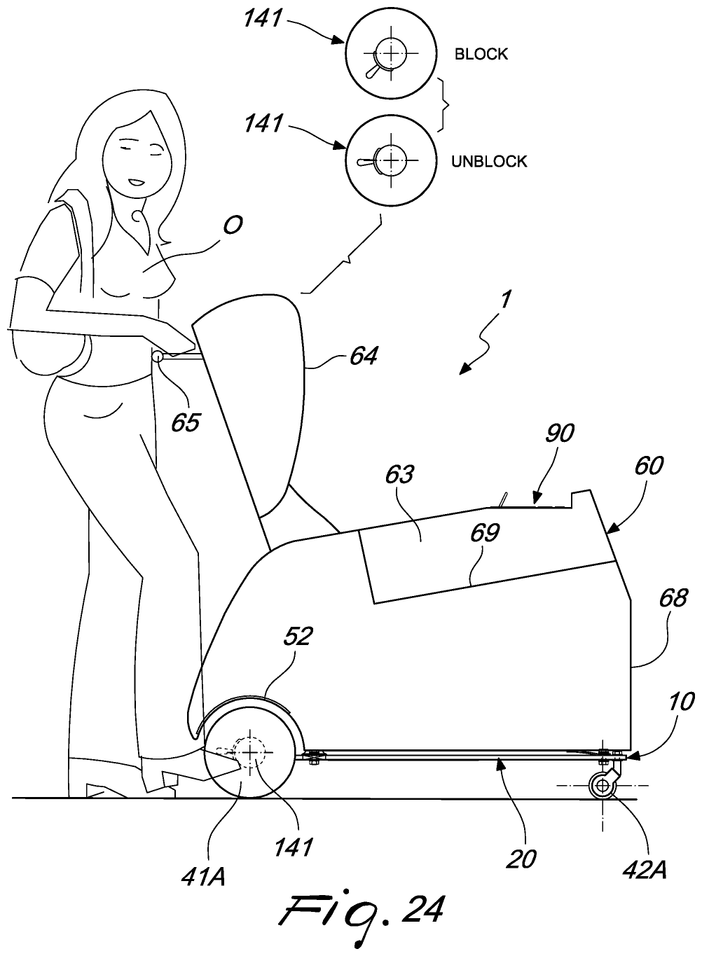

With reference to FIGS. 1-24, the motorized armchair for the movement of a person P, and in particular of a person with motor impairments, designated generally by the reference numeral 1, comprises an adjustable motorized armchair structure 6 of a known type.

The expression “adjustable motorized armchair structure” 6 is meant, in a fully general manner, any structure, even an existing one, of an adjustable motorized armchair which comprises a back 64, a seat 69 and preferably also a footrest 68 adapted to support the legs of the person P.

The adjustable motorized armchair structure 6 comprises furthermore at least one mechanical movement system 66, which is configured to move and/or adjust the back 64, the seat 69 and the optional footrest 68.

In greater detail, the seat 69, the back 64 and the optional footrest 68 can be mutually oriented (i.e., at least one can vary its inclination with respect to the other) and/or moved with respect to the ground fin a mutually integral manner (i.e., they can be moved simultaneously, for example by tilting or being raised with respect to the ground f).

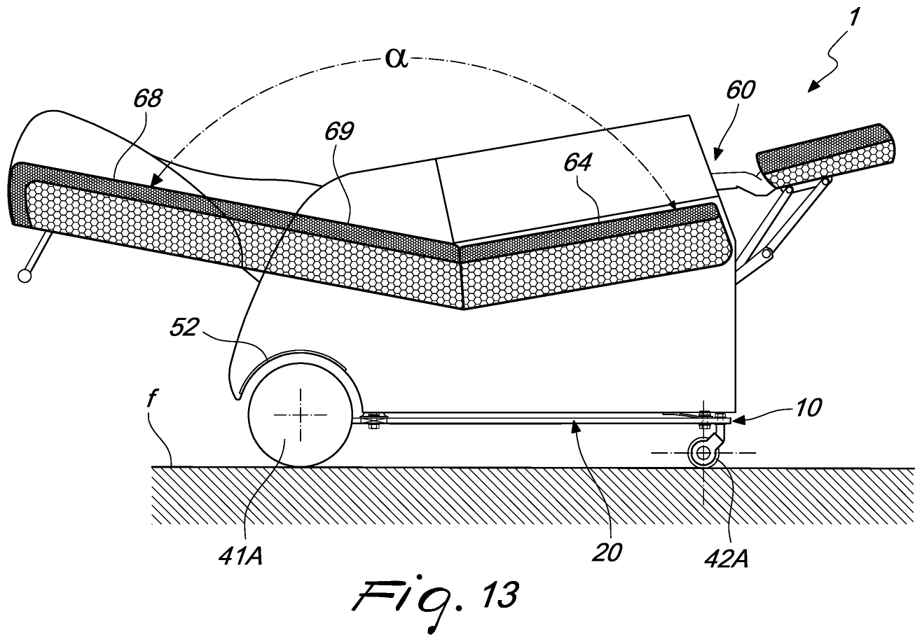

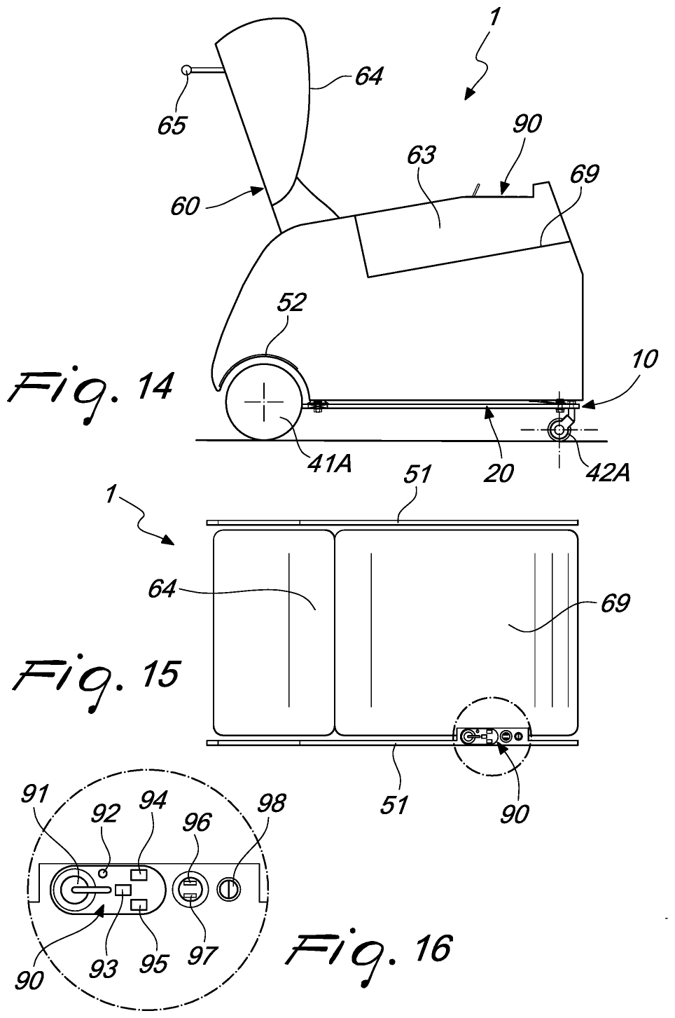

Preferably, in a known manner, the seat 69 and the back 64 (and the optional footrest 68) can be mutually oriented at least between a sitting configuration (shown for example in FIGS. 11 and 14), in which the seat 69 and the back 64 are substantially perpendicular or in any case the person P can sit in the armchair 1 resting his back against the back 64, and a reclined configuration (shown for example in FIG. 13), in which the seat 69 and the back 64 (and the optional footrest 68) are substantially coplanar or in any case the person P can lie on the armchair 1 in a reclined or partially reclined position.

In the preferred embodiment, in the reclined condition the footrest 68 and the seat 69 are aligned along a same plane, which forms, together with the back 64, an angle α of preferably approximately 170°, as shown in FIG. 13.

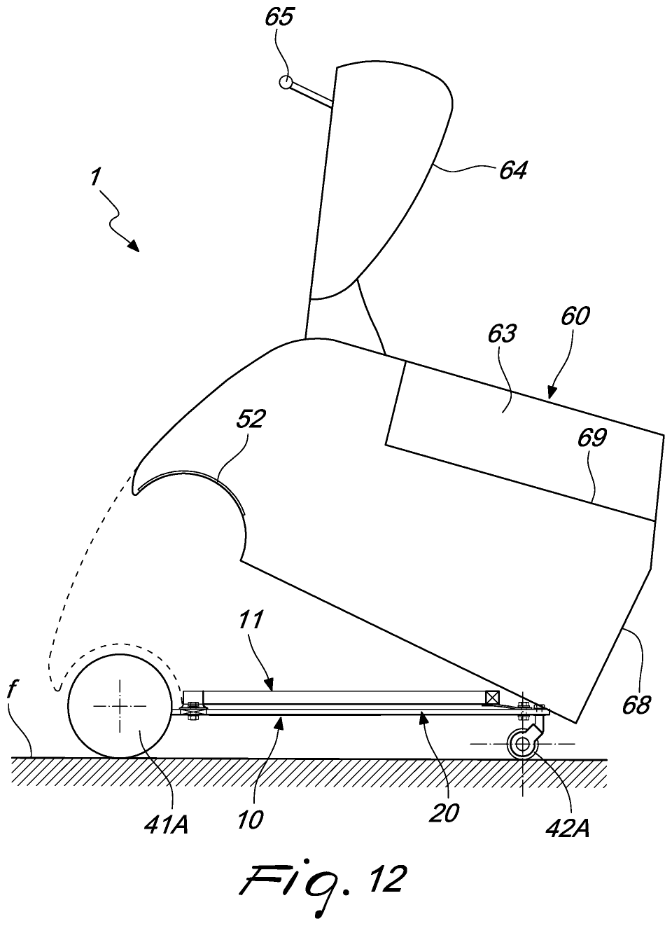

The seat 69, the back 64 and the optional footrest 68 furthermore can be moved integrally (i.e., by being moved simultaneously without rotating with respect to each other) between a lowered position (shown in FIG. 11), in which the seat 69 is substantially parallel to the floor, and a raised position (shown in FIG. 12), in which the seat 69 is inclined with respect to the floor f so as to make it easier for the patient P who is sitting in the armchair 1 to get up.

As already mentioned, the adjustable motorized armchair structure 6 comprises, in a known manner, also a mechanical movement system 66, provided with at least one actuator 117, 118 which is preferably electric (not visible in FIG. 1) and with kinematic transmission means 661 (i.e., appropriate kinematic systems), which are configured to move and/or orient the seat 69, the back 64 and the optional footrest 68, guiding the movements described above.

In some embodiments, the adjustable motorized armchair structure 6 comprises two or more mechanical movement systems 66, each provided with a respective actuator 117, 118, for example a first mechanical movement system adapted to guide the transition from the sitting position to the reclined position (and vice versa) and a second mechanical movement system adapted to guide the transition from the lowered condition to the raised condition (and vice versa).

The adjustable motorized armchair structure 6 furthermore comprises a resting base 11 which is adapted to be arranged adjacent to the ground f. It is specified that the term “ground f” is understood to reference any surface (for example a floor or the outdoor ground) on which the armchair 1 is to be placed.

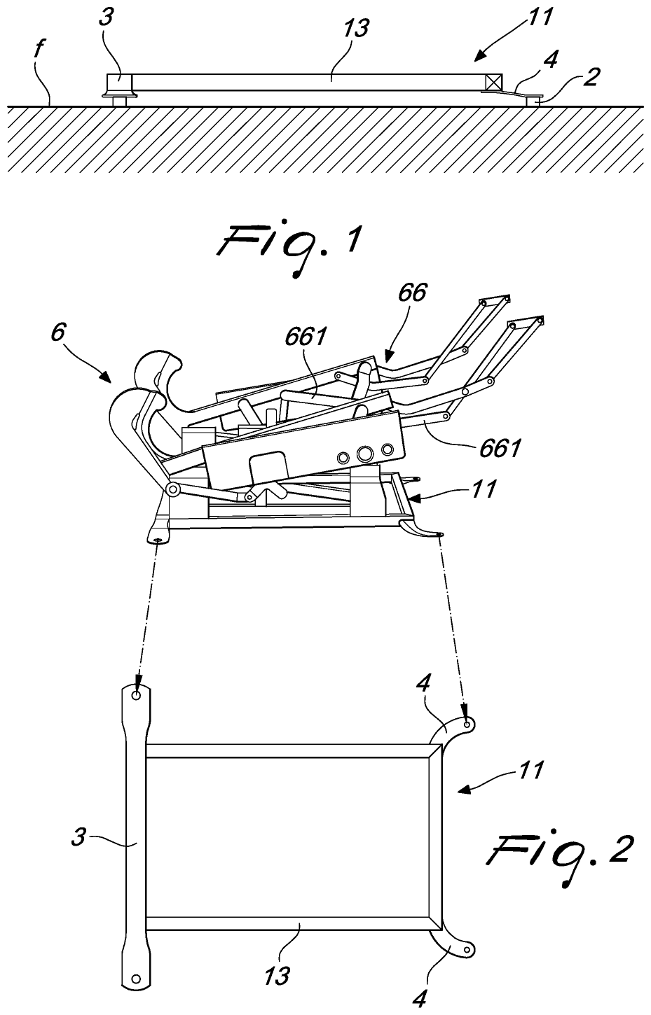

In the preferred and illustrated embodiment, with particular reference to FIGS. 1 and 2, the resting base 11 comprises a base frame 13, preferably made of square box-type iron, to which the following are fixed: a crossmember 3, preferably made of square box-type iron, which is pressed at its ends, and one or two contoured brackets 4, preferably made of solid iron. Even more preferably, the base frame 13 and the crossmember are powder-coated.

It should be noted that the base frame 13 and the cross-member 3 substantially form a rectangle.

Advantageously, two rubber pads 2 are arranged at the two ends of the contoured bracket 4.

The description of the adjustable motorized armchair structure 6 is not continued further, since it is per se known: the person skilled in the art can choose any adjustable motorized armchair structure 6, even an existing one, of the type that has just been described.

According to the disclosure, the armchair 1 comprises a support and movement structure 10 which is adapted to be fixed to the armchair 6, between the resting base 11 and the floor f, and more precisely fixed to the resting base 11 by virtue of mechanical fixing means 31, such as for example bolts, nuts and washers or the like.

In greater detail, the support and movement structure 10 comprises a supporting frame 20, to which are fixed at least two driving wheels 41A, 41B, actuated by at least one preferably electric motor 4A, 4B, and at least two steerable wheels 42A, 42B, so as to allow the movement of the motorized armchair 1 along the ground f and thus allow the person P to use the armchair 1 as a means of locomotion.

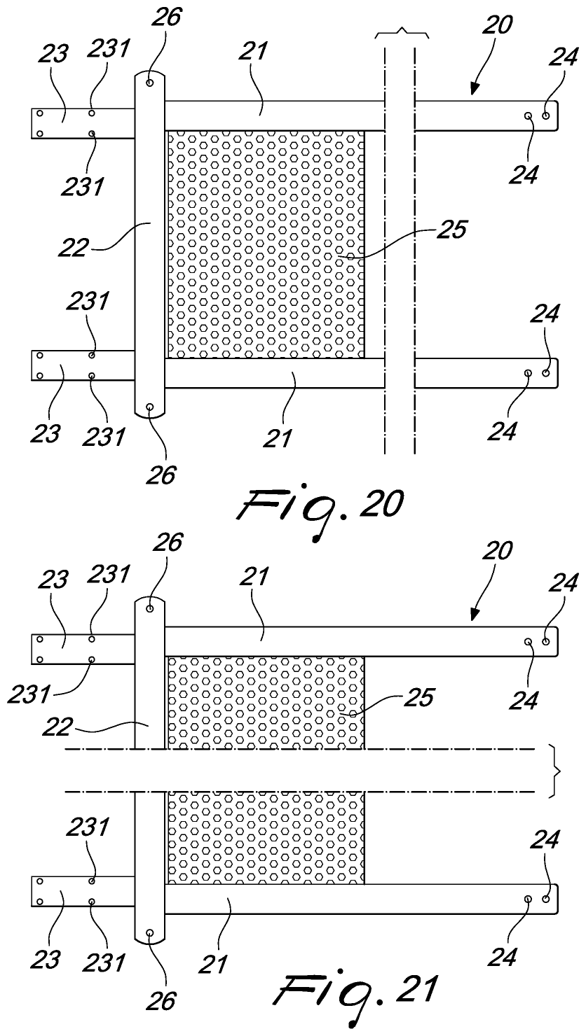

Advantageously, the supporting frame 20 is configured so as to be able to vary its dimensions so that it can be adapted to any adjustable motorized armchair structure 6, as shown schematically in FIGS. 20 and 21.

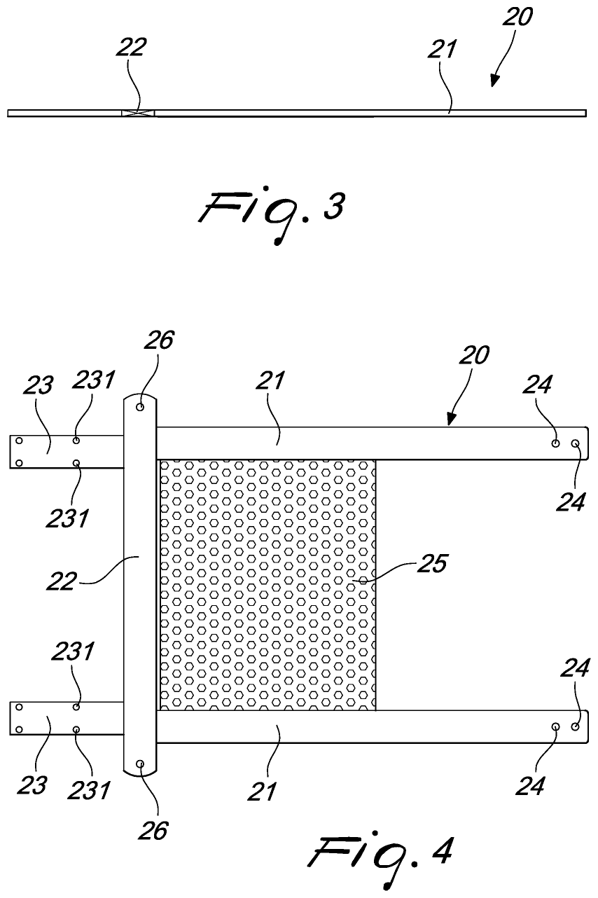

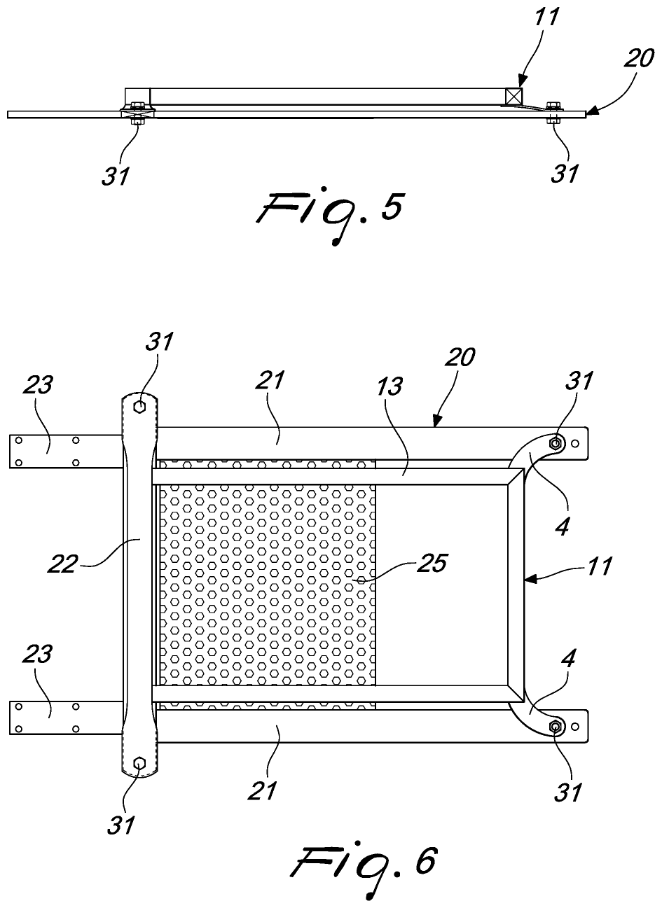

In greater detail, with particular reference to the example shown in FIGS. 3 and 4, the supporting frame 20 comprises: two longitudinal elements 21, such as for example flat bars made of preferably powder coated solid iron, connected at one end by a transverse element 22, such as for example a solid iron bar also preferably power coated and provided, at its ends, with holes 26 for fixing to the resting base 11.

The supporting frame 20 further comprises two supporting elements 23 for the driving wheels 41A, 41B, which are provided with perforations 231 for supporting the driving wheels 41A, 41B.

Holes 24 are provided in the longitudinal elements 21, distally with respect to the supporting elements 23, in order to support the steerable wheels 42A, 42B.

A supporting element 25 is fixed between the longitudinal elements 21 in order to support the battery 106 and the controller 105, which will be described hereinafter, and is constituted preferably by a microperforated metal plate which is welded to the longitudinal elements 21.

In the preferred and illustrated embodiment, there are two driving wheels 41A, 41B arranged to the rear.

These two driving wheels 41A, 41B are independent and each one is actuated by a respective independent motor 4A, 4B.

It should be noted from FIG. 8 that each motor 4A, 4B is advantageously adjacent and fixed to the respective driving wheel 41A, 41B.

The steerable wheels 42A, 42B are preferably casters provided within an axially offset pivot.

In the illustrated example, the driving wheels 41A, 41B have a diameter of approximately 203 mm and the steerable wheels 42A, 42B have a diameter of approximately 60 mm. Advantageously, these dimensions, together with the thrust of the two motors 4A, 4B (which in this embodiment each have a power of 250 W), allow the armchair 1 to climb over steps of 30 mm while traveling forward and 80 mm while traveling backward.

Furthermore, the two motors 4A, 4B are appropriately synchronized to as to be able to make the armchair 1 change trajectory during movement on the floor f, to the point of rotating it while stationary through 360° as shown in FIG. 18, thus allowing to turn in very tight spaces.

According to an optional and advantageous characteristic, the driving wheels 41A, 41B are provided with a release device 141, which allows to uncouple said driving wheels 41A, 41B from the respective motor 4A, 4B so as to render them free to rotate in order to allow the movement of the armchair 1 by pushing on the part of an operator O.

In the illustrated example, in particular in FIG. 14, the release device 141 comprises a lever which is adapted to be actuated by the foot of the operator O in order to pass from the locked condition (indicated as “block”), in which the driving wheels 41A, 41B are coupled to the motor 4A, 4B, to the release position (indicated as “unblock”), in which the driving wheels 41A, 41B are uncoupled from the motor 4A, 4B and can rotate freely.

In order to facilitate movement by pushing, the armchair 1 also comprises a movement handle 65, which is adapted to be pushed or pulled in order to guide the movement of the armchair 1.

Preferably, the driving wheels 41A, 41B also comprise an automatic locking system which locks the driving wheels 41A, 41B themselves when the power supply of the at least one motor 4A, 4B is interrupted. In addition, or as an alternative, the automatic locking system can be configured to lock the driving wheels 41A, 41B if another predetermined condition occurs which can be detected by the automatic locking system itself, such as for example the exceeding of a threshold speed or acceleration or tilt.

Conveniently, protective housings 52, preferably made of aluminum, are arranged over each motor 4A, 4B.

Furthermore, the armchair 1 comprises, fixed to the two sides of the adjustable motorized armchair structure 6, two protective and finishing bulkheads, preferably made of coated metal plate covered with fabric or PVC, which in practice constitute the side walls that define the shape of the armchair 1.

Going back to the general features of the disclosure, the armchair 1 according to the disclosure also comprises a control interface 90, which is functionally connected to the at least one motor 4A, 4B and to the at least one actuator 117, 118 in order to control the movements of the seat 69 and of the back 64 (and of the optional footrest 68) on the part of the mechanical movement system 66 and also the movement of the motorized armchair 1 by the driving wheels 41A, 41B.

Advantageously, the control interface 90 is arranged so that it is within the reach of the person P who is sitting in the armchair 1 and preferably on one of the bulkheads 51 or on one of the armrests 63 that will be described hereinafter.

The control interface 90 preferably comprises a dashboard which in turn comprises one or more of the following elements:
a control lever 91 (or joystick), in order to control the movements of the armchair 1;
a power-on button 92;
an acoustic warning device 93;
a first input element 94 and a second input element 95, such as for example buttons or levers, adapted to control respectively the increase and decrease of the rotation rate of the driving wheels and therefore the advancement speed of the armchair 1.

Optionally, preferably arranged adjacent to the control interface 90, there are furthermore on the armchair 1:
a switch 98 for activating service lights (preferably LEDs) for night use or in low-visibility conditions;
a first USB port 96 for the electrical connection of electronic devices (for example telephones) and their charging;
a second USB port 97 for the connection of a service light (preferably an LED) with a bracelet which can be shaped and with touch power-on at one end.

In practice, the control interface 90 allows to control from a single dashboard all the functions of the armchair 1, including movement on the part of the driving wheels 41A, 41B and the transitions from the sitting condition to the reclined position and from the lowered position to the raised position.

Conveniently, the armchair 1 comprises one or more batteries 106 for supplying power to the motors 4A, 4B, to the actuators 117, 118 and to the other elements that require power (such as for example the service lights and the USB ports 96, 97).

Preferably, the armchair 1 comprises a single battery 106, which supplies power both to the motors 4A, 4B and to the actuators 117, 118 and also to the other elements.

In the preferred embodiment, said battery 106 is a rechargeable 24 V 6A lithium battery, which allows a range of 30 km.

Obviously, the control interface 90, the motors 4A, 4B, the actuators 117, 118 and the battery 106 are functionally connected by means of an electronic system 100 which comprises electric circuits and at least one appropriately configured electronic controller 105.

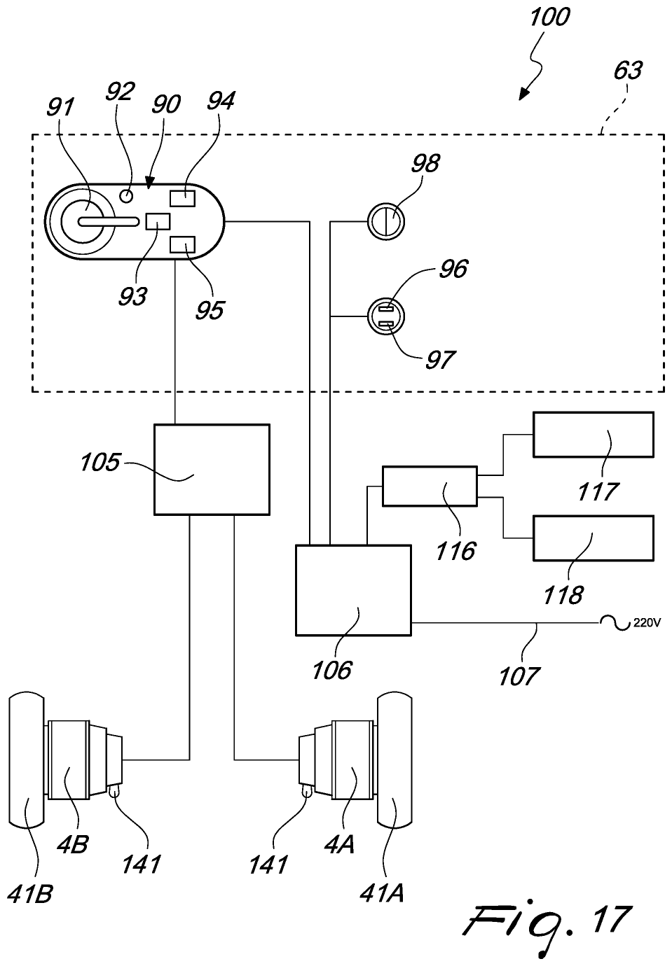

A block diagram of the electronic system 100 of the preferred embodiment is shown in FIG. 17.

In this embodiment, the battery 106 is connected to electrical connection means 107 in order to connect the battery 106 to an AC power source for charging.

It should be noted that the first actuator 117 and the second actuator 118 are connected to a controller 105.

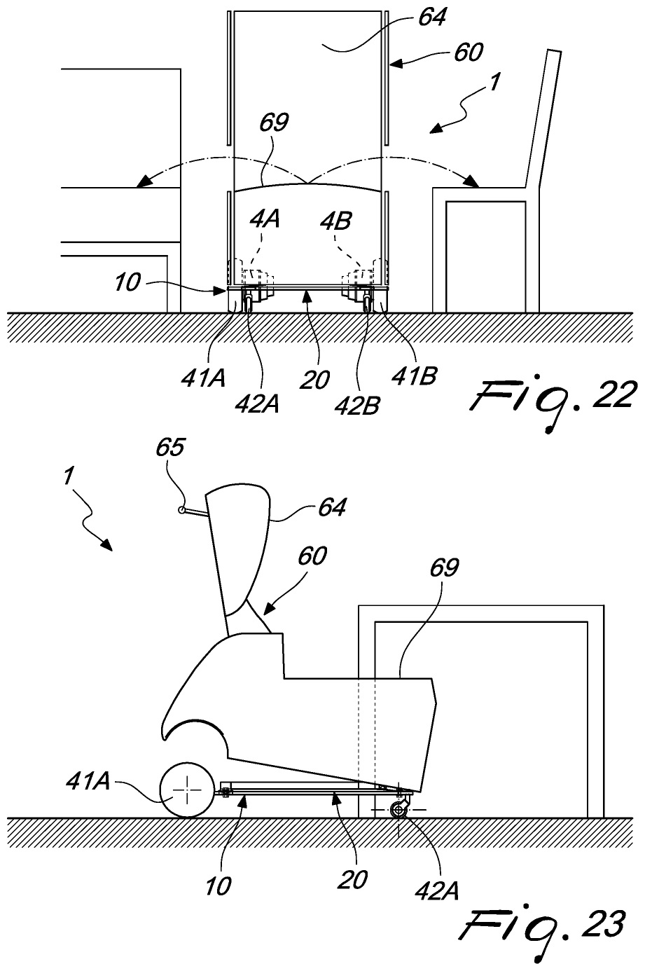

Advantageously, the armchair 1 comprises two extractable armrests 63, which can be removed in order to make the translation of the person P from the armchair 1 to a chair or a bed comfortable, as shown in FIG. 22.

In the preferred embodiment, the seat 69 has a width of 50 cm and, once the armrests 63 have been extracted, the armchair has a width of approximately 59 cm, being able to pass through doors that are 60 cm wide.

Again in the preferred embodiment, the armchair 1 is padded with polyurethane foam and covered by a layer of so-called memory foam on the entire portion in contact with the body of the person P (i.e., on the seat 69, on the back 64, on the footrest 68, on the armrests 63), providing benefit, breathability and comfort above current standards; the fabric that covers everything is of the fire-retardant, breathable, non-absorbent type.

For the sake of greater safety of the person P, the armchair 1 is optionally provided with a seatbelt.

Advantageously, the stability of the armchair 1 is ensured by the support and movement structure 10, which in the preferred embodiment measures 939 mm in length and 532 mm in width, being tipping-resistant.

The present disclosure also relates to a support and movement structure 10 with the characteristics of the one described above, which can be fixed to any motor adjustable motorized armchair structure 6 so as to provide in practice a motorized armchair 1 such as the one described so far.

The operation of the motorized armchair is clear and evident from what has been described.

In practice it has been found that the motorized armchair according to the present disclosure achieves the intended aims and advantages, since it allows to have the conveniences, advantages and functions that are typical of a motorized armchair of the known type and at the same time allows to move from one place to another.

Another advantage of the armchair according to the disclosure resides in that it is more versatile and convenient to use with respect to the background art.

Another advantage of the motorized armchair according to the disclosure allows locomotion both in home environments and in outdoor environments, coping with small rises, level differences and grassy paths, giving freedom and autonomy of movement to people with small and great motor impairments.

A further advantage of the armchair according to the disclosure resides in that it allows autonomy of movement, without cables, for 30 days use in domestic use or for 20 km in outdoor use.

Another advantage of the armchair according to the disclosure resides in that it allows a person with motor impairments to move autonomously within his or her own home without the aid of someone, even outdoors, in a garden.

For example, a young disabled person can receive his guests at home in a motorized armchair instead of in a classic wheelchair, reacquiring security and dignity.

The motorized armchair thus conceived is susceptible of numerous modifications and variations, all of which are within the scope of the accompanying claims. All the details may furthermore be replaced with other technically equivalent elements.

In practice, the materials used, so long as they are compatible with the specific use, as well as the contingent shapes and dimensions, may be any according to the requirements.

1. A motorized armchair for the movement of a person, the motorized armchair comprising an adjustable motorized armchair structure comprising:
a resting base adapted to be arranged adjacent to a ground,
a seat and a back which can be oriented with respect to each other and/or moved integrally with respect to each other relative to the ground,
at least one mechanical movement system, provided with at least one actuator and with kinematic transmission means, configured to move and/or orient said seat and said back,
comprising a support and movement structure adapted to be fixed to said armchair structure, between the resting base and the ground, comprising:
a supporting frame to which at least two driving wheels actuated by at least one motor and at least two steerable wheels are fixed so as to allow the movement of the motorized armchair along said ground;
and further comprising a control interface which is functionally connected to said at least one motor and to said at least one actuator in order to actuate the movements of the seat and of the back and the movement of the motorized armchair.

2. The motorized armchair according to claim 1, further comprising a footrest;
said footrest, said seat and said back being mutually orientable between a sitting configuration and a reclined configuration and being movable integrally between a lowered position, in which said seat is substantially parallel to the floor, and a raised position, in which said seat is raised and/or inclined with respect to said ground so as to make it easier for the person who is sitting in said armchair to get up;
said at least one mechanical movement system being configured to move said footrest, said seat and said back between said sitting configuration and said reclined configuration and between said lowered position and said raised position.

3. The motorized armchair according to claim 1, wherein said supporting frame is fixed to said resting base by mechanical fixing means.

4. The motorized armchair according to claim 1, comprising two independent driving wheels, each of which is actuated by a respective independent motor.

5. The motorized armchair according to claim 1, wherein said two motors are synchronized to configure the armchair change trajectory during movement on said ground, to the point of making it turn through 360° while stationary.

6. The motorized armchair according to claim 1, comprising a battery which powers said at least one motor and said at least one actuator.

7. The motorized armchair according to claim 1, wherein said driving wheels are provided with a release device which allows to uncouple said driving wheels from said at least one motor, so as to render said driving wheels free to rotate in order to allow the movement of the armchair by pushing on the part of an operator.

8. The motorized armchair according to claim 1, wherein said driving wheels comprise an automatic locking system which locks said driving wheels when the power supply of said at least one motor is interrupted and/or if another predetermined condition that can be detected by the automatic locking system occurs.

9. The motorized armchair according to claim 1, wherein the supporting frame can vary its dimensions so that the supporting frame can be adapted to any adjustable motorized armchair structure.

10. A support and movement structure, adapted to be fixed to an adjustable motorized armchair structure that comprises at least one resting base, a back and a seat;
said support and movement structure comprising a supporting frame, which is adapted to be fixed to said resting base and to which at least two driving wheels actuated by at least one motor and at least two steerable wheels are fixed so as to allow the movement of the adjustable motorized armchair structure along a ground.
